(19) United States
(12) Patent Application Publication
(10) Pub. No.: US 2024/0232896 A1
(43) Pub. Date: Jul. 11, 2024

(54) SPLITTING RECURRING CHARGES

(71) Applicant: American Express Travel Related Services Company, Inc., New York, NY (US)

(72) Inventors: Ian T. MORITZ, New York, NY (US); Ian P. PULICE, Los Angeles, CA (US); Adam KROCHAK, New York, NY (US); Mukund Shankar SIMHARAGHU, Glendale, AZ (US)

(73) Assignee: American Express Travel Related Services Company, Inc., New York, NY (US)

(21) Appl. No.: 18/095,679

(22) Filed: Jan. 11, 2023

(51) Int. Cl. G06Q 20/40; G06Q 20/34

(52) U.S. Cl. CPC G06Q 20/405; G06Q 20/351

(57) ABSTRACT

Disclosed herein are aspects for splitting a recurring charge. An example method aspect begins by receiving transaction information specifying a transaction. The method continues by determining whether the transaction is recurring. When the transaction is determined to be recurring, the method creates a split protocol for the transaction based on an input from a user interface of a first user device. The split protocol specifies how to split the transaction with one or more other parties. The method then continues with several operations for each of the respective one or more other parties. Based on the split protocol, the method generates a split request specifying a portion of the transaction the respective other party should pay. The method then sends the split request to a second user device corresponding to the respective other party. The method can repeat the generating and sending steps for subsequent recurrences of the transaction.

### BACKGROUND

Transaction information may list goods or services being transferred, and a bill or amount due for the goods or services. Sometimes transaction information indicates that the charge for the goods or services is recurring. For example, a charge from a subscription service or a utility company may be recurring.

Sometimes, more than one person may be responsible for these recurring charges. For example, when two people are roommates, a subscription charge may be applied to one roommate's credit card, who must seek reimbursement from the other roommate for his or her share. In this way, the charge is often resolved by a single payer and/or payment device. A payment request is sent from the single payer and/or payment device to each person. Therefore, it is useful for the single payer and/or payment device to have the ability to configure recurring payment requests, accounting for differing payments and groups of responsible people.

### SUMMARY

In an aspect, an example method for splitting a recurring charge is described. The method begins by receiving transaction information specifying a transaction. The transaction information can include merchant information, location information, time information, and/or a transaction amount. The method continues by determining whether the transaction is recurring. When the transaction is determined to be recurring, the method continues by creating a split protocol for the transaction based on an input from a user interface of a first user device. The split protocol specifies how to split the transaction with one or more other parties. The method then continues with several operations for each of the respective one or more other parties. Based on the split protocol, the method generates a split request specifying a portion of the transaction the respective other party should pay. The method then sends the split request to a second user device corresponding to the respective other party. The method can repeat the generating and sending steps for subsequent recurrences of the transaction.

System, device, and non-transitory computer-readable medium aspects are also disclosed.

Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the pertinent art to make and use the disclosure.

FIG. 1 is a block diagram of an example system for splitting a recurring charge, according to some aspects of the present disclosure.

FIGS. 2A-2C are example views of user interfaces when splitting a recurring charge, according to some aspects of the present disclosure.

FIG. 3 is a flowchart of a method for splitting a recurring charge, according to some aspects of the present disclosure.

FIG. 4 is a block diagram of an example computer system useful for implementing various aspects.

In the drawings, like reference numbers generally indicate identical or similar elements. Additionally, generally, the left-most digit(s) of a reference number identifies the drawing in which the reference number first appears.

Aspects of the present disclosure will be described with reference to the accompanying drawings.

### DETAILED DESCRIPTION

Provided herein are method, system, non-transitory computer-readable medium, and/or device aspects, and/or combinations and sub-combinations thereof for splitting a recurring charge. Automated splitting of recurring charges reduces the number of computer interactions needed, improving utilization of the network and computing resources. For example, by determining whether a transaction is recurring and creating an overarching split protocol for that recurring transaction, the network and computing resources can send split requests to other devices without needing individually configured protocols. In addition, through use of the split protocol, the network and computing resources can autonomously send split requests for subsequent recurrences of the transaction.

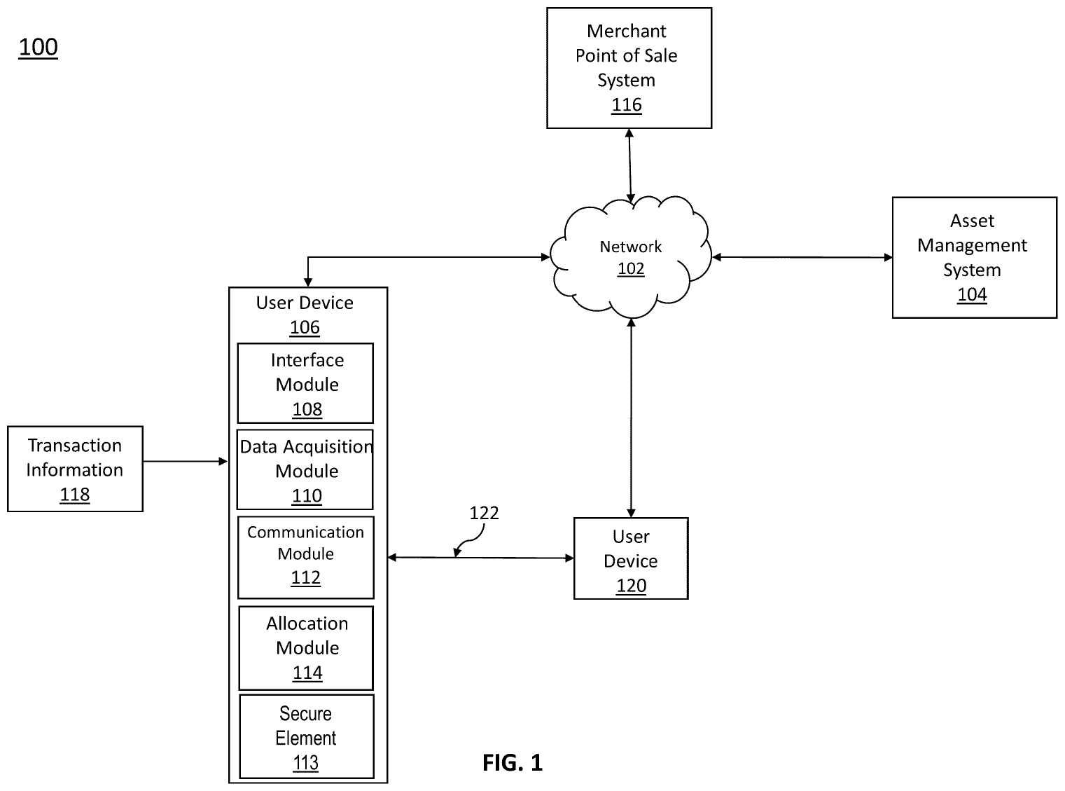

FIG. 1 shows an example system 100 for splitting a recurring charge. System 100 is merely an example of one suitable system environment and is not intended to suggest any limitation as to the scope of use or functionality of aspects described herein. System 100 should not be interpreted as having any dependency or requirement related to any single device/module/component or combination of devices/modules/components described therein.

The system 100 may include a network 102. Network 102 may include a packet-switched network (e.g., internet protocol-based network), a non-packet switched network (e.g., quadrature amplitude modulation-based network), and/or the like. Network 102 may include network adapters, switches, routers, modems, and the like connected through wireless links (e.g., radiofrequency, satellite) and/or physical links (e.g., fiber optic cable, coaxial cable, Ethernet cable, or a combination thereof). Network 102 may include public networks, private networks, wide area networks (e.g., Internet), local area networks, and/or the like. Network 102 may provide and/or support communication from a telephone, cellular phone, modem, and/or other electronic devices to and throughout the system 100. For example, system 100 may include and support communications between user devices 106 and 120 and an asset management system 104 via network 102.

Asset management system 104 may include a payment network, a blockchain network, an asset transferal network, and/or may support/facilitate transactions (e.g., financial transactions, asset exchange transactions, cryptocurrency-related transactions, digital asset-related transactions, etc.).

Asset management system 104 may be configured to determine when a transaction is recurring. Asset management system 104 can determine when a transaction is recurring by monitoring past related transactions. Past transaction amounts, past transaction times (i.e., data and time), or past transaction merchants may be indicative of a recurring pattern with a particular transaction. For example, charges of $5 from merchant X on the first day of the past five month may be indicative of a recurring transaction. Asset management system 104 can also determine when a transaction is recurring by detecting a data item in transaction information transmitted by the merchant of the transaction (e.g., transaction information 118 received from merchant point of sale system 116). For example, a merchant may include a data item within the transaction information that explicitly indicates a recurring transaction. Additionally, asset management system 104 can determine when a transaction is recurring by detecting a virtual card number in transaction information that is mapped to the merchant of the transaction. In this case, the merchant, indicated by the virtual card number, can be determined to regularly transact in recurring transactions. For example, a virtual card number may indicate a transaction with merchant X, and it may be known that merchant X only transacts through monthly subscriptions.

Asset management system 104 may contain an artificial intelligence, machine learning, or other similar system to determine whether a transaction is recurring. In other words, transactions known to be recurring can be explicitly labeled as such. Label categories can include, but are not limited to, a number and frequency of previous transactions from a merchant, a timing for each of the previous transactions, a description for each of the previous transactions, a dollar amount for each of the previous transactions, a timing or dollar amount variance between previous transactions, a name of the merchant, a location of the merchant, a business type of the merchant, characteristics of other transactions from the same merchant, transaction data transmitted from the merchant to the system in a transaction submission or settlement file (i.e., purchase characteristics not available to users), etc. This labeled data can be used to train the system to recognize other transactions that are recurring. This training data is used to build a model that can detect whether other, unlabeled transactions are recurring. The machine learning system can include decision trees, k-nearest neighbors, support vector machines (SVM), neural networks (NN), recurrent neural networks (RNN), convolutional neural networks (CNN), probabilistic neural networks (PNN), and/or transformers. RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, and/or genetic scale RNNs. In a number of embodiments, a combination of machine classifiers can be utilized, more specific machine classifiers when available, and general machine classifiers at other times can further increase the accuracy of predictions.

Asset management system 104 may also include a payment network that may provide, facilitate, and/or support one or more applications, and/or protocols, such as Amex® Pay, and the like. The payment network may facilitate transactions between merchants and card issuers. The payment network may approve or deny a purchase conducted at a merchant. The payment network may include an encryption to protect sensitive user data. The payment network may be configured to interact with one or more other payment networks. The payment network may be a Real-Time Payment (RTP) network. The RTP network may provide real-time payments from banking institutions.

User devices 106 and 120 may be configured to communicate with the payment network of asset management system 104 and transmit pull and push payment requests/messages. For example, the pull and push payment requests/messages may be payment requests/messages associated with transactions, inter-device payment requests and/or funds transferals, and/or the like. User devices 106 and 120 may be configured with an application and/or an application programming interface (API) that includes services, libraries, code, a combination thereof, and/or the like. The application and/or the API may enable user devices 106 and 120 to communicate with the payment network of asset management system 104 and send pull and push payment messages. For example, user device 106 may send a request to split a transaction to user device 120 through asset management system 104. In this example, user device 106 may send a message to the payment network of asset management system 104 to send a split request (e.g., an apportioned amount of a transaction, etc.) to an entity (e.g., a device/network associated with a financial institution that issues a payment account, etc.) based on a request from a digital wallet and/or the like of user device 106. Asset management system 104 may facilitate notifications to user device 106 when split requests are fulfilled, or may facilitate reminders to user device 120 to fulfill split requests.

Asset management system 104 may include a blockchain to support the payment network. The blockchain may be a distributed database that maintains records in a readable manner and that is resistant to tampering. The blockchain may include a system of interconnected blocks containing data. The blocks can hold transfer data, smart contract data, and/or other information (e.g., digital assets, etc.) as desired. Each block may link to the previous block and may include a timestamp. When implemented in support of asset management system 104, the blockchain may serve as an immutable log for API transactions and related communications. The blockchain may be a peer-to-peer network that is private, consortium, and/or public (e.g., Ethereum, Bitcoin, etc.). Consortium and private networks may offer improved control over the content of the blockchain and public networks (e.g., network 102, etc.) may leverage the cumulative computing power of the network to improve security. The blockchain may be implemented using technologies, for example, Ethereum GETH, eth-light wallet, or other suitable blockchain interface technologies. The blockchain may be maintained on various nodes in the form of copies of the blockchain. Validation of API transactions may be added to the blockchain by establishing consensus between the nodes based on proof of work, proof of stake, practical byzantine fault tolerance, delegated proof of stake, or other suitable consensus algorithms.

Merchant point of sale system 116 can be a software system, a hardware system, or a combination thereof. Merchant point of sale system 116 can be configured to complete a sale between a merchant and customer, process a return between the merchant and customer, track inventory, track business performance, maintain a loyalty program, print receipts, etc. For example, merchant point of sale system 116 can complete a sale between a merchant and customer, can print a receipt for the customer, and can upload the sale information to a network for tracking of business performance. In some aspects, the sale information can be shared with other businesses (e.g., shared with asset management system 104 via network 102). Merchant point of sale system 116 can also be configured to transfer money from a customer's bank account or credit card account to the merchant's bank account.

User device 106 may include a smart device, a mobile device, a computing device, and/or any other device capable of communicating with network 102 and/or device/components in communication with network 102. Although user device 106 is shown and described in greater detail than user device 120, user devices 106 and 120 may be similarly configured and perform similarly and/or execute/operate with the same functionality. Additionally, system 100 can be configured to allow more than two user devices to communicate over network 102. For example, user devices 106 and 120 can communicate with as many other user devices as capable over network 102.

User device 106 may include an interface module 108. Interface module 108 enables a user to interact with user device 106, network 102, user device 120, asset management system 104, merchant point of sale system 116, transaction information 118, and/or any other device/component of the system 100. Interface module 108 may include any interface for presenting and/or receiving information to/from a user.

Interface module 108 may include a web browser, a user interface of an application (e.g., AMEX PAY®, etc.), and/or the like. For example, if a transaction is determined to be recurring by asset management system 104, interface module 108 may include a user interface through which a user corresponding to user device 106 can create a protocol specifying how to split the transaction (i.e., a split protocol) with one or more other parties (e.g., a user of user device 120). The split protocol user interface can include several input fields: a field specifying how many other parties will be splitting a transaction, a field corresponding to each of the other parties indicating their respective payment account information, a field corresponding to each of the other parties indicating their respective debt amounts (e.g., $5.00) or percentages (e.g., 10% of total), a field indicating whether the transaction should still be split based on the split protocol if the transaction amount differs from previous related transactions (e.g., March 2021 was $5.00, but April 2021 was $5.01), a field indicating an amount of permissible variance in the transaction amount for the split request to be sent, a field indicating an amount of time or a term for which recurring split requests will be sent (e.g., split requests should be sent for the next 6 months), a field indicating whether to aggregate more than one unrelated transaction identified as recurring into the split request (i.e., where one or more other parties have multiple recurring transactions with a user, a single split request could be sent to each of the other parties for the multiple recurring transactions), or a field presenting a picture of a receipt corresponding to the transaction. The picture of the receipt corresponding to the transaction can be provided by a user (e.g., through user device 106) or a merchant (e.g., through merchant point of sale system 116). Interface module 108 can also provide a prompt or alert on user device 106 for completion of the split protocol for the recurring transaction.

When a request to split the transaction (i.e., split request) is generated based on the split protocol, a user can provide an input to send the split request to another user (e.g., to user device 120) or the request can be generated automatically. The split request can then be displayed on a user interface of user device 120. The split request can include merchant information, the transaction amount, a debt amount or percentage specific to the user, or a picture of a receipt corresponding to the transaction.

Other software, hardware, and/or interfaces can be used to provide communication between user device 106, network 102, user device 120, asset management system 104, transaction information 118, and/or any other device/component of the system 100. Interface module 108 may be used to display, request, and/or send data/information from a local source and/or a remote source, such as network 102, user device 120, asset management system 104, transaction information 118, and/or any other device/component of the system 100. Interface module 108 may be and/or may include any interface for presenting and/or receiving information to/from a user. For example, interface module 108 can display a notification on a user interface of user device 106 when a split request based on a split protocol is fulfilled. This notification can be generated by network 102, asset management system 104, or another component of system 100. Interface module 108 can also display a notification on a user interface of user device 120 as a reminder to fulfill a split request based on a split protocol. This reminder can be generated by network 102, asset management system 104, or another component of system 100.

Interface module 108 may include one or more input devices and/or components, for example, such as a keyboard, a pointing device (e.g., a computer mouse, remote control), a microphone, a joystick, a tactile input device (e.g., touch screen, gloves, etc.), and/or the like. Input devices and/or components of interface 108 may include hardware input devices and/or components, software input devices and/or components, virtual input devices and/or components, physical input devices and/or components, and/or the like. Interaction with the input devices and/or components may enable a user to view, access, request, and/or navigate a user interface generated, accessible, and/or displayed by interface module 108. Interaction with the input devices and/or components may enable a user to manipulate and/or interact with components of a user interface.

User device 106 may include a data acquisition module 110 for capturing and/or receiving data/information. For example, data acquisition module 110 may include an imaging device/component (e.g., a camera, an imaging sensor, etc.), a data source (e.g., a quick response (QR) code, a near field communication (NFC) tag, a barcode, a watermark, transaction information 118, etc.) scanner, and/or the like for capturing and/or receiving data/information, such as transaction information 118. Data acquisition module 110 can also include a processing module for processing transaction information 118 or information from merchant point of sale system 116.

Data acquisition module 110 may be used to acquire data/information, such as transaction data, imaging data, and/or the like, of transaction information 118. Transaction information 118 may be and/or may include, but is not limited to, merchant information (e.g., merchant name), location information (e.g., city, state, zip code, country, etc.), time information (e.g., date and time), a transaction amount, a bill for products and/or services rendered, a receipt, a contract, an indication of an engagement arrangement, and/or the like. Transaction information may indicate that the transaction is a pending transaction or an authorized transaction. A pending transaction may be a transaction that has been sent to data acquisition module 110 from a merchant point of sale system, but has not been fully processed by the merchant. For example, a user of the user device 106 may position a camera of the data acquisition module 110 to capture image data of transaction information 118 depicting transaction items. A user of the user device 106 may use data acquisition module 110 to scan and/or decode a QR code (and/or any other encoder indicator) indicative of transaction information 118 depicting transaction items. A user of the user device 106 may use data acquisition module 110 (and/or any other component of user device 106) to acquire transaction information 118 by any means.

Transaction information 118 may be displayed to a user of user device 106, for example, via interface module 108 and/or the like.

User device 106 may include a communication module 112 that facilitates and/or enables communication with network 102 (e.g., devices, components, and/or systems of the network 102, etc.), asset management system 104 (e.g., devices, components, and/or systems of asset management system 104, etc.), user device 120, merchant point of sale system 116, and/or any other device/component of the system 100. Communication module 112 may include any hardware and/or software necessary to facilitate communication including, but not limited to a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. For example, communication module 112 may include multiple radio interfaces that support various wireless communication protocols and/or standards (e.g., Wi-Fi, BLUETOOTH™, LTE, LTE-A, ZigBee, Ant+, near field communications (NFC), UWB (Ultra-wideband), 3G, 4G, 5G, PCS, GSM, etc.). Accordingly, the UE may need to simultaneously operate multiple radio interfaces corresponding to multiple wireless communication protocols and/or standards. Communication module 112 enables wireless, peer-to-peer, ad hoc, automatic, self-configuring high-speed networking between user devices.

Communication module 112 may use a communication protocol 122 (e.g., Bluetooth, NFC, etc.) to detect, determine, and/or identify user devices, for example, user device 120 in proximity to user device 106. Communication module 112 may detect, determine, and/or identify user devices, for example, user device 120 in proximity to user device 106 in response to activation and/or the initiation of an application (e.g., AMEX PAY®, etc.) and/or the like configured with user device 106.

Communication module 112 may use a communication protocol 122 (e.g., Ultra-wideband (UWB), Wi-Fi Direct, peer-to-peer Wi-Fi, Nearby Share, Multipeer Connectivity, infrared, etc.) to facilitate a peer-to-peer, ad hoc, and high-speed network between user device 106 and any user device detected, determined, and/or identified, for example, user device 120, via protocol 122 and/or selected and/or identified via interaction with interface module 108 and/or the like. Ultra-wideband is a radio technology that can use a very low energy level for short-range, high-bandwidth communications over a large portion of the radio spectrum. An example is an AWDL (Apple Wireless Direct Link) communications protocol, which is a low latency/high-speed WiFi peer-to peer-connection used in the AIRDROP communication product available from Apple Inc. of Cupertino, CA.

To manage asset transferal, user device 106 may include an allocation module 114. Allocation module 114 may be initiated, supported by, in communication with, and/or the like an application (e.g., AMEX PAY®, etc.) and/or the like configured with user device 106. Allocation module 114 may include and/or be associated with a digital wallet. The digital wallet may include payment information and passwords associated with the user device 106 (e.g., associated with a user of the user device 106). For example, the digital wallet may include payment card information. The payment card may be associated with a primary account number (PAN). The PAN may be tokenized for security. The PAN associated with the user device 106 may be stored by asset management system 104 (e.g., a payment network configured with, supported by, and/or enabled by asset management system 104, etc.) in a database record linked to a payment account (and/or user profile) associated with a user (e.g., a user associated with and/or using the user device 106, etc.). The payment account may be maintained/controlled by asset management system 104 (e.g., via an entity of asset management system 104, AMEX®, etc.). As previously described, asset management system 104 may include and/or be part of a device/network associated with a financial institution that issues payment accounts. Monetary assets and/or the like may be transferred between payment accounts associated with user device 106 and user device 120 (and/or users of user device 106 and user device 120, etc.).

Allocation module 114 may include and/or be associated with a crypto wallet (e.g., software, hardware, and/or the like that enables user device 106 to store and use cryptocurrency, etc.). A crypto wallet may be an on-chain crypto wallet, an off-chain crypto wallet (e.g., a cold wallet, a warm wallet, etc.), and/or the like. For example, a crypto wallet may enable and/or facilitate digital assets to be stored (e.g., securely stored, etc.) locally on a storage of and/or associated with the user device 106. A crypto wallet enables transactions to occur with a username and/or identifier that can be associated with a public key address on a blockchain of asset management system 104. User device 106 may utilize a crypto wallet to send and/or receive cryptocurrency assets, payments, and/or the like. The crypto wallet can be used to store a user's public and private keys for accessing and using cryptocurrency. In scenarios where the crypto wallet includes an off-chain crypto wallet, digital assets may be in custody of the user device 106 (and/or user of the user device 106) and stored locally by secure element 113 and/or another storage element of and/or associated with the user device 106. Cryptocurrencies (e.g., Bitcoin, Ethereum, etc.), crypto tokens (e.g., ERC-20, Dogecoin, etc.), and/or the like may be transferred between crypto wallets and/or crypto accounts associated with user device 106 and user device 120 (and/or users of user device 106 and user device 120, etc.).

User device 106 may include a secure element 113. Secure element 113 is configured to be protected from unauthorized access and may be used by the user device 106 to interact/communicate with allocation module 114 to manage and/or store confidential data, cryptographic data, and/or the like. Secure element 113 may enable trusted applications, device components (e.g., digital wallets, crypto wallets, etc.) and/or devices (e.g., POS terminals, merchant devices, loan management terminals, etc.) read and/or write access to storage and/or data of the secure element 113. Secure element 113 may be configured to detect and/or identify any hacking and/or modification attempts, perform cryptographic functions including, but not limited to cryptographically secure generation of random numbers and/or keys (e.g., pairs of private and public keys for asymmetric encryption, etc.). Secure element 113 may include secure memory for storing private encryption keys, bank card details, digital assets, and/or any other information securely. Secure element 113 may store keys for digitally signing documents or other data, as well as generating a signature. Secure element 113 may store and/or facilitate cryptocurrency wallets and/or the like. Secure element 113 may store biometric data/information and/or facilitate safe storage and/or transfer of sensitive data.

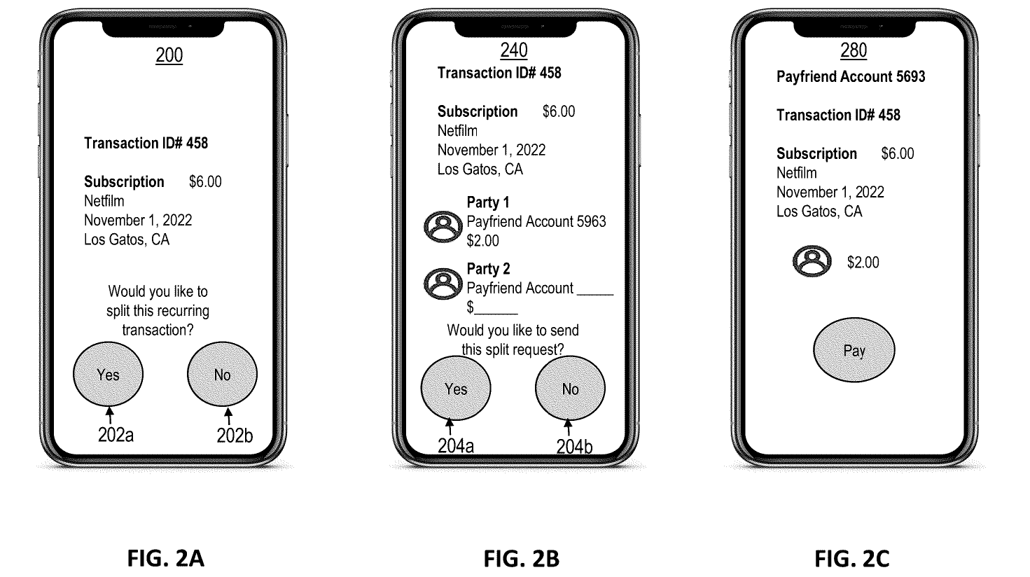

FIGS. 2A-2C are example views of user interfaces when splitting a recurring charge.

FIG. 2A is a user interface 200 of transaction information for a transaction determined to be recurring, and a prompt to create a split protocol for the transaction. A system corresponding to user interface 200 can receive transaction information (e.g., transaction information 118) specifying a transaction. The transaction information may be and/or may include, but is not limited to, merchant information (e.g., merchant name), location information (e.g., city, state, zip code, country, etc.), time information (e.g., date and time), a transaction amount, a bill for products and/or services rendered, a receipt, a contract, an indication of an engagement arrangement, and/or the like. Transaction information may indicate that the transaction is a pending transaction or an authorized transaction.

Another system (e.g., asset management system 104) can then determine whether the transaction is recurring. The system can determine when a transaction is recurring by monitoring past related transactions. Past transaction amounts, past transaction times (i.e., data and time), or past transaction merchants may be indicative of a recurring pattern with a particular transaction. For example, charges of $5 from merchant X on the first day of the past five month may be indicative of a recurring transaction. The system can also determine when a transaction is recurring by detecting a data item in transaction information transmitted by the merchant of the transaction (e.g., transaction information 118 received from merchant point of sale system 116). For example, a merchant may include a data item within the transaction information that explicitly indicates a recurring transaction. Additionally, the system can determine when a transaction is recurring by detecting a virtual card number in transaction information that is mapped to the merchant of the transaction. In this case, the merchant, indicated by the virtual card number, can be determined to regularly transact in recurring transactions. For example, a virtual card number may indicate a transaction with merchant X and it may be known that merchant X only transacts through monthly subscriptions.

The system may contain an artificial intelligence, machine learning, or other similar system to determine whether a transaction is recurring. In other words, transactions known to be recurring can be explicitly labeled as such. This labeled data can be used to train the system to recognize other transactions that are recurring. This trained system can then determine whether a transaction is recurring.

When the transaction is determined to be recurring, the transaction information, an indication that the transaction is recurring, and/or a prompt, alert, or input field prompting a user to create a split protocol for the recurring transaction can be presented on user interface 200 (e.g., user interface of user device 106). For example, a user can be prompted with a “Yes” input field 202a and a “No” input field 202b, corresponding to the question of whether they would like to split this recurring transaction (i.e., whether they would like to create a split protocol for the transaction). If the user selects input field 202a through their user device (e.g., user device 106), then the user interface can transition to a user interface 240 to create the split protocol.

FIG. 2B is a user interface 240 for creating a split protocol for a transaction determined to be recurring, generating a split request based on the split protocol, and sending the split request to user devices of one or more other parties. The split protocol specifies how to split the recurring transaction with one or more other parties (e.g., a user of user device 120). The split protocol can include several input fields: a field specifying how many other parties will be splitting a transaction, a field corresponding to each of the other parties indicating their respective payment account information, a field corresponding to each of the other parties indicating their respective debt amounts (e.g., $5.00) or percentages (e.g., 10% of total), a field indicating whether the transaction should still be split based on the split protocol if the transaction amount differs from previous related transactions (e.g., March 2021 was $5.00, but April 2021 was $5.01), a field indicating an amount of permissible variance in the transaction amount for the split request to be sent, a field indicating an amount of time or a term for which recurring split requests will be sent (e.g., split requests should be sent for the next 6 months), a field indicating whether to aggregate more than one unrelated transaction identified as recurring into the split request (i.e., where one or more other parties have multiple recurring transactions with a user, a single split request could be sent to each of the other parties for the multiple recurring transactions), or a field presenting a picture of a receipt corresponding to the transaction. The picture of the receipt corresponding to the transaction can be provided by a user (e.g., through user device 106) or a merchant (e.g., through merchant point of sale system 116). A user can provide inputs for one or more of the input fields through their user device (e.g., user device 106) to create the split protocol.

Once the split protocol is creased, a split request can be generated based on the split protocol. The split request is the request provided to each one or more other parties (e.g., a user of user device 120) indicated as needing to fulfill a portion of the recurring transaction. When the split request is generated based on the split protocol, a user can provide an input to send the split request to another user (e.g., to user device 120) or the request can be generated automatically. A user (e.g., user corresponding to user device 106) can be prompted to send the split request by a prompt, alert, or input field presented on user interface 240 (e.g., user interface of user device 106). For example, a user can be prompted with a “Yes” input field 204a and a “No” input field 204b, corresponding to the question of whether they would like to send the split request. If the user selects input field 204a through their user device (e.g., user device 106), then the split request can be sent to another user device (e.g., user device 120) for fulfillment.

FIG. 2C is a user interface 280 for a split request to be fulfilled. The split request specifies a portion of the transaction a respective other party (e.g., a user corresponding to user device 120) should pay. The split request can include merchant information, the transaction amount, a debt amount or percentage specific to the user, or a picture of a receipt corresponding to the transaction. Split requests can be sent to more than one user owing a portion of the recurring transaction (e.g., sent over network 102 by user device 106).

User devices used for creation of the split protocol, sending the split request, or fulfilling the split request can be configured to receive one or more notifications or reminders on the user interfaces, such as those presented in FIGS. 2A-2C. For example, user interfaces can display a notification when a split request based on a split protocol is fulfilled. The user interface can also display a notification as a reminder to fulfill a split request based on a split protocol. Based on the split protocol, future split requests can be generated and sent for fulfillment. For example, if a split protocol is created for a March 2021 recurring transaction and a split request is sent to a user owing a portion of the transaction. If the transaction recurs in April 2021 and the split protocol is appropriately configured (e.g., proper term and proper amount), then the split request can also be generated and sent for the recurrence of the transaction.

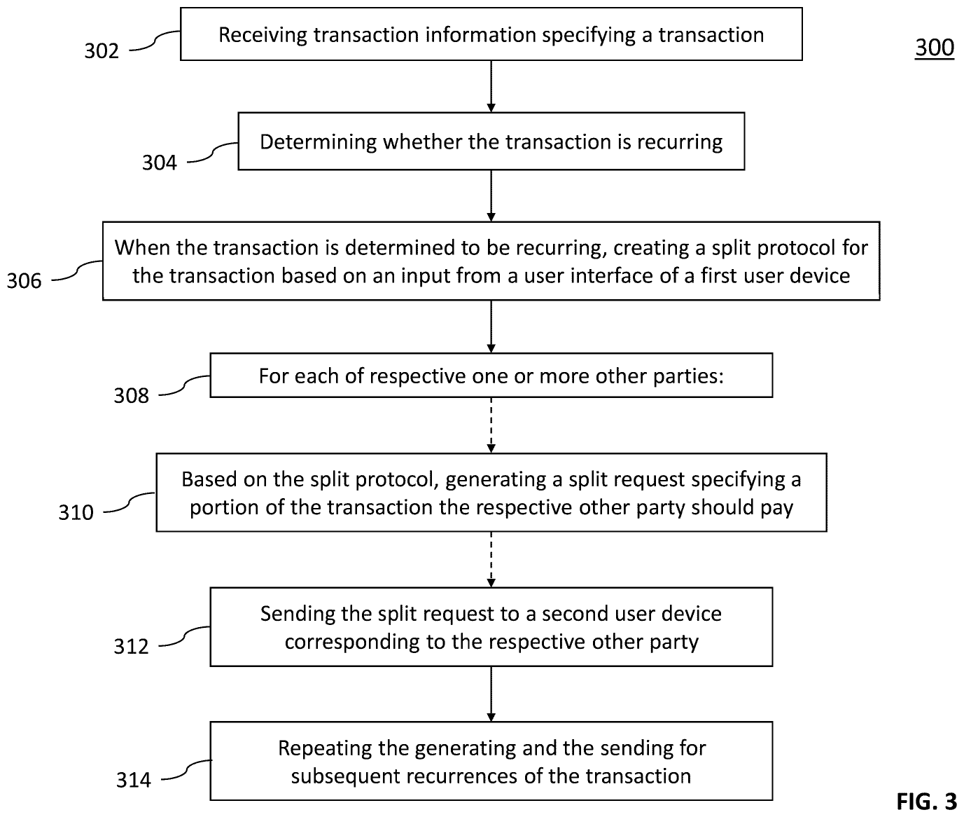

FIG. 3 is a flowchart for a method 300 for splitting a recurring charge, according to an aspect of the invention. It is to be appreciated that not all steps can be needed to perform the disclosure provided herein. Further, some of the steps can be performed simultaneously, or in a different order than shown in FIG. 3, as will be understood by a person of ordinary skill in the art.

Method 300 can be implemented by system 100 and operations caused by computer system 400. However, method 300 is not limited to that example aspect.

In 302, transaction information specifying a transaction is received. The transaction information can includes merchant information, location information, time information, and/or a transaction amount. Transaction information may indicate that the transaction is a pending transaction or an authorized transaction.

In 304, it is determined whether the transaction is recurring. A system can determine whether the transaction is recurring. The system can determine when a transaction is recurring by monitoring past related transactions. Past transaction amounts, past transaction times (i.e., data and time), or past transaction merchants may be indicative of a recurring pattern with a particular transaction. The system can also determine when a transaction is recurring by detecting a data item in transaction information transmitted by the merchant of the transaction. Additionally, the system can determine when a transaction is recurring by detecting a virtual card number in transaction information that is mapped to the merchant of the transaction. In this case, the merchant, indicated by the virtual card number, can be determined to regularly transact in recurring transactions. As described above, the system may contain an artificial intelligence, machine learning, or other similar system to determine whether a transaction is recurring. In other words, transactions known to be recurring can be explicitly labeled as such. This labeled data can be used to train the system to recognize other transactions that are recurring. This trained system can then determine whether a transaction is recurring.

When a transaction is determined to be recurring in 304, a split protocol for the transaction is created in 306 based on an input from a user interface of a first user device. The split protocol specifies how to split the transaction with one or more other parties.

The split protocol can include several input fields: a field specifying how many other parties will be splitting a transaction, a field corresponding to each of the other parties indicating their respective payment account information, a field corresponding to each of the other parties indicating their respective debt amounts (e.g., $5.00) or percentages (e.g., 10% of total), a field indicating whether the transaction should still be split based on the split protocol if the transaction amount differs from previous related transactions (e.g., March 2021 was $5.00, but April 2021 was $5.01), a field indicating an amount of permissible variance in the transaction amount for the split request to be sent, a field indicating an amount of time or a term for which recurring split requests will be sent (e.g., split requests should be sent for the next 6 months), a field indicating whether to aggregate more than one unrelated transaction identified as recurring into the split request (i.e., where one or more other parties have multiple recurring transactions with a user, a single split request could be sent to each of the other parties for the multiple recurring transactions), or a field presenting a picture of a receipt corresponding to the transaction. The picture of the receipt corresponding to the transaction can be provided by a user or a merchant.

In 308, operations are triggered for each of the respective one or more other parties.

In 310, based on the split protocol, a split request is generated. The split request specifies a portion of the transaction the respective other party should pay. The split request can include merchant information, the transaction amount, a debt amount or percentage specific to the user, or a picture of a receipt corresponding to the transaction.

In 312, the split request is send to a second user device corresponding to the respective other party. User devices used for creation of the split protocol, sending the split request, or fulfilling the split request can be configured to receive one or more notifications or reminders on the user interfaces. For example, user interfaces can display a notification when a split request based on a split protocol is fulfilled. The user interface can also display a notification as a reminder to fulfill a split request based on a split protocol.

In 314, additional split requests can be generated and send for subsequent recurrences of the transaction. The additional split requests are based on the split protocol created in 306.

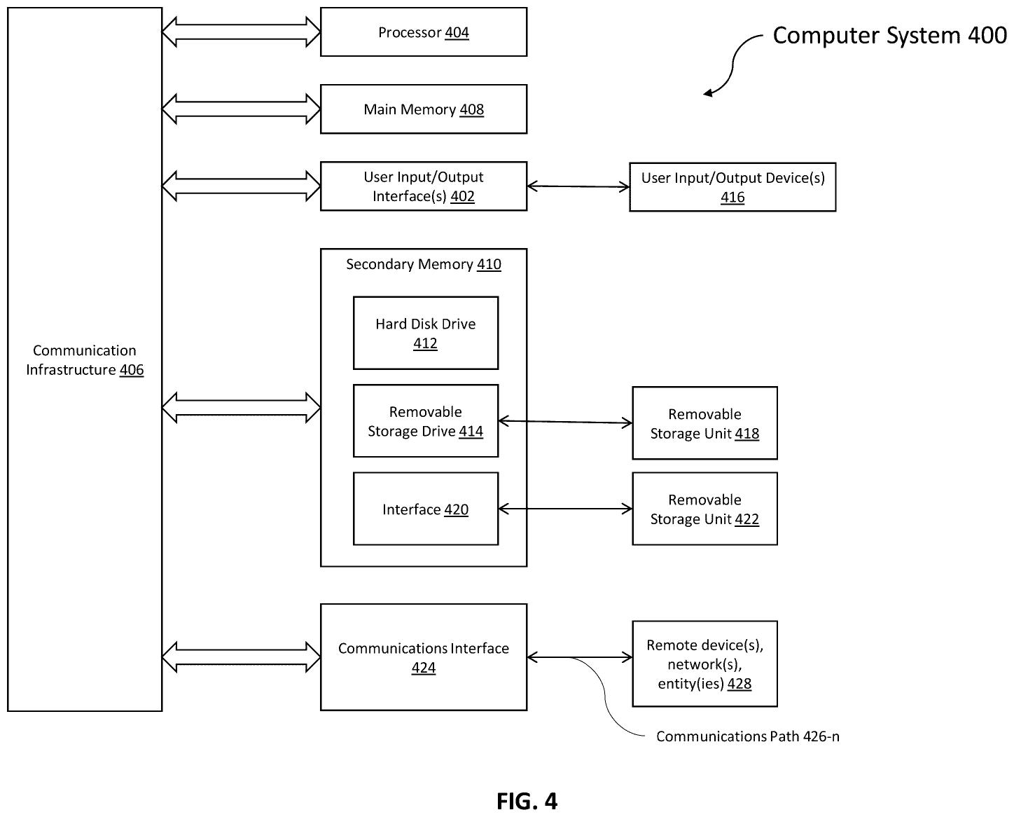

Various aspects can be implemented, for example, using one or more computer systems, such as computer system 400 shown in FIG. 4. Computer system 400 can be used, for example, to implement a system for splitting a recurring charge. Computer system 400 can be any computer capable of performing the functions described herein.

Computer system 400 can be any well-known computer capable of performing the functions described herein.

Computer system 400 includes one or more processors (also called central processing units, or CPUs), such as a processor 404. Processor 404 is connected to a communication infrastructure or bus 406.

One or more processors 404 may each be a graphics processing unit (GPU). In an aspect, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 also includes user input/output device(s) 416, such as monitors, keyboards, pointing devices, etc., that communicate with communication infrastructure 406 through user input/output interface(s) 802.

Computer system 400 also includes a main or primary memory 408, such as random access memory (RAM). Main memory 408 may include one or more levels of cache. Main memory 408 has stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to an exemplary aspect, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

In an aspect, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), causes such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 4. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A method for splitting a recurring charge, comprising:
receiving transaction information specifying a transaction, wherein the transaction information includes at least one of merchant information, location information, time information, or a transaction amount;
determining whether the transaction is recurring;
when the transaction is determined to be recurring, creating a split protocol for the transaction based on an input from a user interface of a first user device, the split protocol specifying how to split the transaction with one or more other parties;
for each of the respective one or more other parties:
based on the split protocol, generating a split request specifying a portion of the transaction the respective other party should pay;
sending the split request to a second user device corresponding to the respective other party; and
repeating the generating and the sending for subsequent recurrences of the transaction.

2. The method of claim 1, wherein the transaction information indicates that the transaction is a pending transaction sent from a merchant point of sale system.

3. The method of claim 1, wherein determining whether the transaction is recurring comprises:
monitoring past transaction amounts, past transaction times, and past transaction merchants to determine if a recurring pattern exists with one or more transactions.

4. The method of claim 1, wherein determining whether the transaction is recurring comprises:
detecting a data item in the transaction information from a merchant corresponding to the transaction, wherein the data item is indicative of a recurring transaction.

5. The method of claim 1, wherein determining whether the transaction is recurring comprises:
detecting a virtual card number in the transaction information that is mapped to a merchant corresponding to the transaction, wherein the merchant regularly transacts in recurring transactions.

6. The method of claim 1, wherein the split protocol includes at least one of the one or more other parties, account information for each respective other party, a debt amount for each respective other party, a debt percentage for each respective other party, whether the split request is to be sent if the transaction amount differs from previous related transactions, a permissible variance in the transaction amount for the split request to be sent, a term for which recurring split requests will be sent, whether to aggregate more than one unrelated transactions identified as recurring into the split request, or a picture of a receipt corresponding to the transaction.

7. The method of claim 1, further comprising:
prompting a first user to create the split protocol through input on the user interface of the first user device for the transaction determined to be recurring.

8. The method of claim 1, wherein the split request includes at least one of the merchant information, the transaction amount, a debt amount, a debt percentage, or a picture of a receipt corresponding to the transaction.

9. The method of claim 1, further comprising:
generating a notification on the first user device when the split request is fulfilled.

10. The method of claim 1, further comprising:
generating a reminder on the second user device to fulfill the split request.

11. A system for splitting a recurring charge, comprising:
a payment network;
a first user device communicatively coupled to the payment network;
a second user device communicatively coupled to the payment network; and
a computing device comprising a processor and a memory, wherein the computing device is communicatively coupled to the payment network and wherein the memory contains instructions stored thereon that when executed by the processor cause the computing device to:
receive transaction information specifying a transaction, wherein the transaction information includes at least one of merchant information, location information, time information, or a transaction amount;
determine whether the transaction is recurring;
when the transaction is determined to be recurring, create a split protocol for the transaction based on an input from a user interface of the first user device, the split protocol specifying how to split the transaction with one or more other parties;
for each of the respective one or more other parties:
based on the split protocol, generate a split request specifying a portion of the transaction the respective other party should pay;
send the split request to the second user device corresponding to the respective other party; and
repeat the generating and the sending for subsequent recurrences of the transaction.

12. The system of claim 11, wherein to determine whether the transaction is recurring comprises:
monitoring past transaction amounts, past transaction times, and past transaction merchants to determine if a recurring pattern exists with one or more transactions.

13. The system of claim 11, wherein to determine whether the transaction is recurring comprises:
detecting a data item in the transaction information from a merchant corresponding to the transaction, wherein the data item is indicative of a recurring transaction.

14. The system of claim 11, wherein to determine whether the transaction is recurring comprises:
detecting a virtual card number in the transaction information that is mapped to a merchant corresponding to the transaction, wherein the merchant regularly transacts in recurring transactions.

15. The system of claim 11, wherein the split protocol includes at least one of the one or more other parties, account information for each respective other party, a debt amount for each respective other party, a debt percentage for each respective other party, whether the split request is to be sent if the transaction amount differs from previous related transactions, a permissible variance in the transaction amount for the split request to be sent, a term for which recurring split requests will be sent, whether to aggregate more than one unrelated transactions identified as recurring into the split request, or a picture of a receipt corresponding to the transaction.

16. The system of claim 11, wherein the split request includes at least one of the merchant information, the transaction amount, a debt amount, a debt percentage, or a picture of a receipt corresponding to the transaction.

17. A non-transitory computer-readable medium having instructions stored thereon that, when executed by at least one computing device, cause the at least one computing device to perform operations comprising:
receiving transaction information specifying a transaction, wherein the transaction information includes at least one of merchant information, location information, time information, or a transaction amount;
determining whether the transaction is recurring;
when the transaction is determined to be recurring, creating a split protocol for the transaction based on an input from a user interface of a first user device, the split protocol specifying how to split the transaction with one or more other parties;
for each of the respective one or more other parties:
based on the split protocol, generating a split request specifying a portion of the transaction the respective other party should pay;
sending the split request to a second user device corresponding to the respective other party; and
repeating the generating and the sending for subsequent recurrences of the transaction.

18. The non-transitory computer-readable medium of claim 17, wherein determining whether the transaction is recurring comprises:
monitoring past transaction amounts, past transaction times, and past transaction merchants to determine if a recurring pattern exists with one or more transactions.

19. The non-transitory computer-readable medium of claim 17, wherein determining whether the transaction is recurring comprises:
detecting a data item in the transaction information from a merchant corresponding to the transaction, wherein the data item is indicative of a recurring transaction.

20. The non-transitory computer-readable medium of claim 17, wherein the split protocol includes at least one of the one or more other parties, account information for each respective other party, a debt amount for each respective other party, a debt percentage for each respective other party, whether the split request is to be sent if the transaction amount differs from previous related transactions, a permissible variance in the transaction amount for the split request to be sent, a term for which recurring split requests will be sent, whether to aggregate more than one unrelated transactions identified as recurring into the split request, or a picture of a receipt corresponding to the transaction.
